(19) United States
(12) Patent Application Publication
(10) Pub. No.: US 2021/0286469 A1
(43) Pub. Date: Sep. 16, 2021

(54) TOUCH SCREEN AND MANUFACTURING METHOD THEREOF

(71) Applicant: WUHAN CHINA STAR OPTOELECTRONICS SEMICONDUCTOR DISPLAY TECHNOLOGY CO., LTD., Wuhan (CN)

(72) Inventor: Ming Xie, Wuhan (CN)

(21) Appl. No.: 16/624,925

(22) PCT Filed: Sep. 29, 2019
(86) PCT No.: PCT/CN2019/108936

§ 371 Date: Dec. 20, 2019

(30) Foreign Application Priority Data
Aug. 13, 2019 (CN) 201910744668.X

(51) Int. Cl. G06F 3/044

(52) U.S. Cl. CPC G06F 3/0445; G06F 2203/04103; G06F 2203/04111

(57) ABSTRACT

A touch screen and a manufacturing method thereof are provided. The touch screen includes an array substrate, and the array substrate includes a thin film encapsulation layer, an insulating layer, a first metal layer, a passivation layer, a second metal layer, and a planar layer. There is a via hole disposed on the passivation layer. The first metal layer has a recess at a position corresponding to the via hole. The second metal layer extends through the via hole into the recess of the first metal layer and is electrically connected to the first metal layer.

### BACKGROUND OF INVENTION

### Field of Invention

The present invention belongs to the technical filed of touch control, and more particularly, to a touch screen and a manufacturing method thereof.

### Description of Prior Art

With the rapid development of display technology, active matrix organic light-emitting diodes (AMOLEDs), having flexible display, have attracted great attention, and these include full-screen, bendable, and even foldable, fixed-curved cell phones that will be broadly used in the future market. Technology of flexible display can alter the shape of display devices, thereby increasing flexibility and diversity of display. It thus can be expected that significant change will be brought to the technical filed of display.

Technology of metal mesh uses metal materials such as silver and copper to form conductive metal mesh patterns on plastic films such as glass and polyethylene terephthalate (PET). The resistivity ratio of the metal mesh is less than that of indium tin oxide (ITO). In general, if target value of sheet resistance (RD) of indium tin oxide (ITO) is 10Ω, then actual value of sheet resistance is between 8Ω and 12Ω. On the other hand, sheet resistance of metal mesh is less than 10Ω/□, such that roll-to-roll production can be achieved. Further, mesh is resistant to bending and can be used in flexible folding devices. Y-OCTA technology is developed by SAMSUNG and be used in technology of flexible touch display. In such technology, metal mesh is directly used as touch leads on thin film encapsulation (TFE), such that thicknesses of original external touch screen (TP) and optical transparent adhesive (OCA) are greatly reduced, and thus the touch devices can be thinner and more favorable for bending. Carbon nanotube (CNT) process is used to connect upper and lower metal layers to form mesh for flexible touch. However, the carbon nanotube process causes higher resistivity between the metals, which reduces touch precision and affects the overall flexible touch performance.

Therefore, it is necessary to provide a new touch screen and a manufacturing method thereof to overcome the problems in the prior art.

### SUMMARY OF INVENTION

The purpose of the present invention is to provide a touch screen and a manufacturing method thereof. By etching a via hole, the present invention can increase the contact area of two metal layers and improve the resistivity of carbon nanotube, such that the reliability of metal mesh at a connection is increased, and the touch performance is improved. Further, the widened feature at the connection improves the flexible dynamic bending performance.

In order to solve the above problems, a touch screen is provided. The touch screen includes an array substrate. The array substrate includes a thin film encapsulation layer, an insulating layer, a first metal layer, a passivation layer, a second metal layer, and a planar layer. Specifically, the insulating layer is disposed on the thin film encapsulation layer, the first metal layer is disposed on the insulating layer, the passivation layer is disposed on the first metal layer, the second metal layer is disposed on the passivation layer, and the planar layer is disposed on the second metal layer.

In one embodiment, the first metal layer includes a plurality of electrode bridges, the second metal layer includes a plurality of touch electrodes and a plurality of metal traces. The touch electrode includes a first electrode and a second electrode, the first electrode and the second electrode are insulated from each other, two adjacent first electrodes are electrically connected to each other through the electrode bridge along a first direction, and two adjacent second electrodes are electrically connected to each other through the metal trace along a second direction which crosses the first direction. There is a plurality of via holes disposed on the passivation layer. The via hole is formed as a hole-shaped structure having a gradually decreasing inner diameter from a surface of the passivation layer close to the first electrode of the second metal layer toward an end of the electrode bridge of the first metal layer. The electrode bridge is recessed to form a recess at a position corresponding to the via hole. The first electrode extends through the via hole into the recess of the electrode bridge and is electrically connected to the first electrode.

In one embodiment, a width of the via hole ranges from 1.4 μm to 1.6 μm.

In one embodiment, a side wall of the via hole is at an angle of 15° to 30° to a perpendicular of a bottom edge of the via hole.

In one embodiment, a bottom of the recess is disposed at a half thickness of the first metal layer.

In one embodiment, the first metal layer or the second metal layer includes a first titanium layer, an aluminum layer, and a second titanium layer, which are disposed in a stack. Specifically, the aluminum layer is disposed at a side of the first titanium layer, and the second titanium layer is disposed at a side of the aluminum layer away from the first titanium layer.

In one embodiment, the first metal layer or the second metal layer includes a silver nanowire.

A method of manufacturing a touch screen includes:

providing an array substrate, in which the array substrate includes a thin film encapsulation layer;

forming an insulating layer on the thin film encapsulation layer;
forming a first metal layer on the insulating layer, in which the first metal layer includes a plurality of electrode bridges;

forming a passivation layer on the first metal layer;
disposing a via hole on the passivation layer;
recessing the first metal layer to form a recess at a position corresponding to the via hole;

forming a second metal layer on the passivation layer, in which the second metal layer includes a plurality of touch electrodes and a plurality of metal traces, the touch electrode includes a first electrode and a second electrode, the first electrode and the second electrode and the second electrode are insulated from each other, two adjacent first electrodes are electrically connected to each other through the electrode bridge along a first direction, two adjacent second electrodes are electrically connected to each other through the metal trace along a second direction which crosses the first direction, the via hole is formed as a hole-shaped structure having a gradually decreasing inner diameter from a surface of the passivation layer close to the first electrode of the second metal layer toward an end of the electrode bridge of the first metal layer, the electrode bridge is recessed to form a recess at a position corresponding to the via hole, and the first electrode extends through the via hole into the recess of the electrode bridge and is electrically connected to the first electrode; and forming a planar layer on the second metal layer.

In one embodiment, a width of the via hole ranges from 1.4 μm to 1.6 μm.

In one embodiment, a side wall of the via hole is at an angle of 15° to 30° to a perpendicular of a bottom edge of the via hole.

In one embodiment, a bottom of the recess is disposed at a half thickness of the first metal layer.

The benefits of the present invention are described below:

The present invention provides a touch screen and a manufacturing method thereof. By etching a via hole, the contact area of two metal layers is increased, the sheet resistance is reduced, the reliability of metal mesh at a connection is improved, the strength of the connection is increased, and the touch performance is improved. Further, the widened feature at the connection improves the flexible dynamic bending performance.

### BRIEF DESCRIPTION OF DRAWINGS

FIG. 1 is a cross-sectional view of a touch screen according to one embodiment of the present invention.

FIG. 2 is a schematic view of a structure of a first metal layer or a second metal layer illustrated in FIG. 1.

FIG. 3 is a partial enlarged view of a structure of a via hole and a recess illustrated in FIG. 1.

FIG. 4 is a process flow diagram showing a method of manufacturing a touch screen according to one embodiment of the present invention.

FIG. 5 is a schematic view of a structure of a touch panel according to one embodiment of the present invention.

Reference numerals are described below:

thin film encapsulation layer: 1; insulating layer: 2; first metal layer: 3; passivation layer: 4; second metal layer: 5; planar layer: 6; polarizing plate: 7; via hole: 8; recess: 9; array substrate: 10; first titanium layer: 11; aluminum layer: 12; second titanium layer: 13; liquid crystal layer: 20; color filter: 30; electrode bridge: 31; touch electrode: 51; metal trace: 52; first electrode: 511; touch screen: 100; and touch panel: 200.

### DETAILED DESCRIPTION OF PREFERRED EMBODIMENTS

The following description is provided by reference to the drawings of the embodiments of the present invention, in order to clearly and completely illustrate the technical solutions of the embodiments of the present invention. It is obvious that the described embodiments are only a part of the embodiments of the present invention, rather than all embodiments. Based on the embodiments of the present invention, the other embodiments obtained by a person skilled in the art without inventive effort fall within the claimed scope of the present invention.

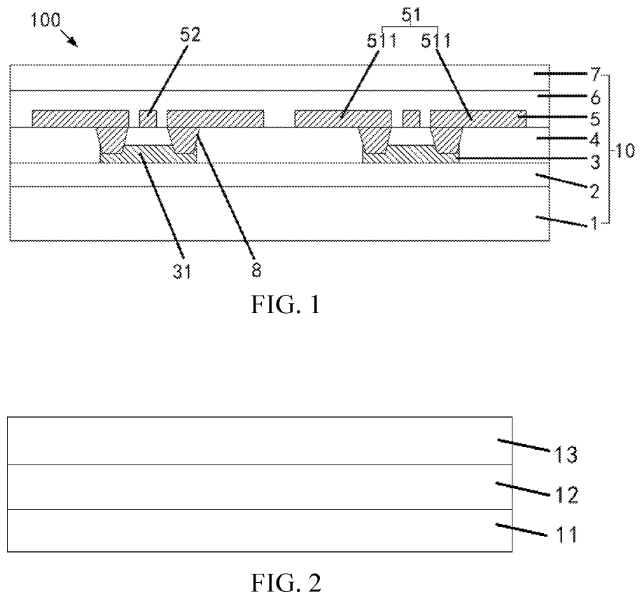

Referring to FIG. 1, the present invention provides a touch screen 100, including an array substrate 10. The array substrate 10 includes a thin film encapsulation layer 1, an insulating layer 2, a first metal layer 3, a passivation layer 4, a second metal layer 5, a planar layer 6, and a polarizing plate 7. Specifically, the insulating layer 2 is disposed on the thin film encapsulation layer 1, the first metal layer 3 is in a form of mesh and disposed on the insulating layer 2, the passivation layer 4 is disposed on the first metal layer 3, the second metal layer 5 is in a form of mesh and disposed on the passivation layer 4, the planar layer 6 is disposed on the second metal layer 5, the planar layer 6 is configured to cover the second metal layer 5 and make its surface smooth, and the polarizing plate 7 is disposed on the planar layer 6 and configured for polarization of a light. The insulating layer 2, the passivation layer 4, and the planar layer 6 are all configured for insulation.

In one embodiment, the first metal layer 3 includes a plurality of electrode bridges 31. The second metal layer 5 includes a plurality of touch electrodes 51 and a plurality of metal traces 52. The touch electrode 51 includes a first electrode 511 and a second electrode (not shown), and the first electrode 511 and the second electrode are insulated from each other. Two adjacent first electrodes 511 are electrically connected to each other through the electrode bridge 31 along a first direction, and two adjacent second electrodes are electrically connected to each other through the metal traces 52, which is in a same layer as the second electrode, along a second direction which crosses the first direction. In other words, the first electrode 511 is arranged along the first direction and has a mesh structure, and two adjacent first electrodes 511 are electrically connected to each other along the first direction to form a first touch sensing part. Further, the second electrode is arranged along a second direction, which crosses the first direction, and has the mesh structure, and two adjacent second electrodes are electrically connected to each other along the second direction to form a second touch sensing part. The first touch sensing part and the second touch sensing part are insulated from each other through the passivation layer 4 to form a bridge structure.

The passivation layer 4 is equipped with a plurality of via holes 8, and the via holes 8 are formed as a hole-shaped structure having a gradually decreasing inner diameter from a surface of the passivation layer 4 close to the first electrode 511 of the second metal layer 5 toward an end of the electrode bridge 31 of the first metal layer 3. The electrode bridge 31 is recessed to form a recess 9 at a position corresponding to the via hole 8. The first electrode 511 extends through the via hole 8 into the recess 9 of the electrode bridge 31 and is electrically connected to the first electrode 511. In one embodiment, a bottom of the recess 9 is disposed at a half thickness of the first metal layer 3; that is to say, a distance between a plane where the bottom of the recess 9 is disposed and a lower surface of the first metal layer 3 is equal to that between the plane and an upper surface of the first metal layer 3. In other words, if the thickness of the first metal layer 3 is 0.2 μm, then a depth of the recess 9 on the first metal layer 3 is 0.1 μm.

The insulating layer 2 and the passivation layer 4 are made of inorganic material which can be flexible material such as, but not limited to, SiN and SiON. A thickness of the passivation layer 4 is 0.3 μm. The planar layer 6 is made of polymethyl methacrylate (PMMA), and a thickness of the planar layer 6 is 2 μm.

The first metal layer 3 includes a plurality of touch electrode wires (i.e., the first touch sensing part and the second touch sensing part as described above) which are insulated from each other. The touch electrode wire may be disposed at a black array on the color filter 30 (referring to FIG. 5) of the touch screen, which is in a vertical projection area on the array substrate 10, such that the impact of the touch electrode wire on an aperture ratio can be reduced. The touch electrode wires crisscross each other to form a form of mesh. The touch electrode wire is connected to a touch chip (not shown), such that a touch signal sensed by the touch electrode 51 is delivered to the touch chip. That is to say, the first metal layer 3 and the second metal layer 5 form a TX-RX touch wiring.

The second metal layer 5 includes a plurality of touch electrodes 51. The plurality of touch electrodes 51 are arranged in an array. Each of the touch electrodes 51 can be in the shape of round, triangular or other shape. The principle of the touch control performed by the plurality of touch electrodes 51 is described below: if a human body does not touch the screen, then the capacitance sensed by the touch electrode 51 will be a constant value; if a human body touches the screen, for example, preforming an operation on the screen by a finger, then the capacitance sensed by the touch electrode 51 at a position where the finger touches the screen will be changed due to the influence of the human body. By detecting the change of capacitance of each of the capacitive touch electrodes, the position touched by the finger can be determined, such that touch function can be achieved.

In one embodiment, the second metal layer 5 serves as a common electrode layer of the array substrate 10 at the same time. In the display phase, the plurality of touch electrode wires of the first metal layer 3 input a common electrode signal which is necessary for display, such that each of the touch electrodes 51 of the second metal layer 5 has the common electrode signal, thereby achieving display. In the touch scanning phase, the plurality of touch electrode wires serve as a touch lead connected to the touch chip, such that the sensing signals from each of the touch electrodes 51 can be delivered to the touch chip, thereby achieving touch function.

In one embodiment, a width of the via hole 8 ranges from 1.4 μm to 1.6 μm. The width of the via hole 8 is preferably 1.5 μm, which is equal to the width of carbon nanotube (CNT). The cross section of the via hole 8 can be in the shape of round, rectangular, triangular or other shape. The present invention achieves the connection between the first metal layer 3 and the second metal layer 5 by using the via hole 8, so as to increase the contact area of the two metal layers, reduce the sheet resistance, improve the reliability of metal mesh at a connection, increase the strength of the connection, and improve the touch performance. Further, the widened feature at the connection improves the flexible dynamic bending performance.

In one embodiment, a side wall of the via hole 8 is at an angle of 15° to 30° to a perpendicular of a bottom edge of the via hole 8. A side wall of the recess 9 and the side wall of the via hole 8 are connected and parallel; that is to say, the side wall of the recess 9 is also at an angle of 15° to 30° to a perpendicular of a bottom edge of the recess 9. The slope of the via hole 8 and the recess 9 can further improve the reliability of metal mesh at a connection, increase the strength of the connection, and increase the contact area with the second metal layer 5. In addition, the connection between the first metal layer 3 and the second metal layer 5 is so wide as to reduce the sheet resistance.

Referring to FIG. 2, in one embodiment, the first metal layer 3 or the second metal layer 5 may include a first titanium layer 11, an aluminum layer 12, and a second titanium layer 13, which are disposed in a stack. Specifically, the aluminum layer 12 is disposed at a side of the first titanium layer 11, and the second titanium layer 13 is disposed at a side of the aluminum layer 12 away from the first titanium layer 11. The first metal layer 3 or the second metal layer 5 may also include a silver nanowire (AgNW). A width of the first metal layer 3 or the second metal layer 5 is 3 μm.

In one embodiment, a thickness of the first titanium layer 11 of the first metal layer 3 is 0.03 μm, a thickness of the aluminum layer 12 of the first metal layer 3 is 0.14 μm, a thickness of the second titanium layer 13 of the first metal layer 3 is 0.03 μm. That is to say, the total thickness of the first metal layer 3 is 0.2 μm. A bottom of the recess 9 is disposed at a half thickness of the first metal layer 3, that is, a depth of the recess 9 in the first metal layer 3 is 0.1 μm.

In one embodiment, a thickness of the first titanium layer 11 of the second metal layer 5 is 0.05 μm, a thickness of the aluminum layer 12 of the second metal layer 5 is 0.28 μm, a thickness of the second titanium layer 13 of the second metal layer 5 is 0.05 μm.

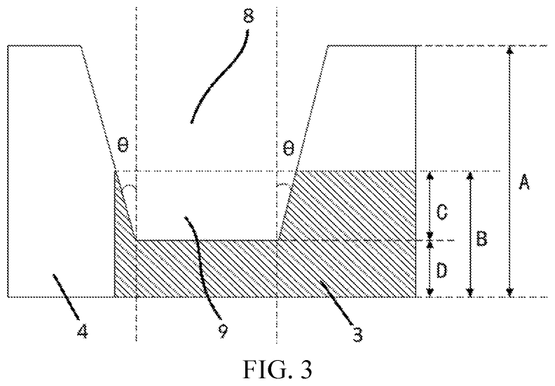

More specifically, referring to FIG. 3, a thickness A of the passivation layer 4 indicated in FIG. 3 is 0.3 μm, a thickness B of the first metal layer 3 is 0.2 μm, a depth C of the bottom of the via hole 8 in the first metal layer 3 is 0.1 μm, that is, a distance D between the bottom of the via hole 8 and the bottom of the first metal layer 3 is 0.1 μm, and thus a depth of the via hole 8 is 0.2 μm. A side wall of the via hole 8 is at an angle θ to a perpendicular of a bottom edge of the via hole 8, and the angle θ ranges from 15° to 30°, preferably being 20°. A side wall of the recess 9 and the side wall of the via hole 8 are connected and parallel; that is to say, the side wall of the recess 9 is also at an angle of 15° to 30° to a perpendicular of a bottom edge of the recess 9. The angle θ of the via hole 8 and the recess 9 can further improve the reliability of metal mesh at a connection, increase the strength of the connection, and increase the contact area with the second metal layer 5. In addition, the connection between the first metal layer 3 and the second metal layer 5 is so wide as to reduce the sheet resistance.

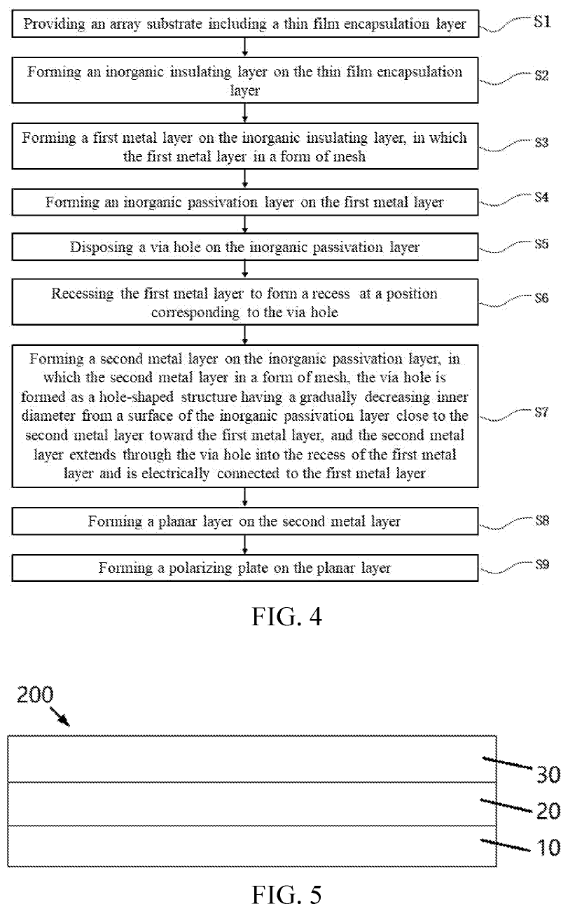

Referring to FIG. 4, the present invention further provides a method of manufacturing a touch screen, including steps S1 to S9.

Step S1: providing an array substrate 10, in which the array substrate 10 includes a thin film encapsulation layer 1, and the thin film encapsulation layer 1 is configured to protect the array substrate 10 by insulating water and oxygen.

Step S2: deposing a layer of SiN or SiON on the thin film encapsulation layer 1 to form an insulating layer 2.

Step S3: forming a first metal layer 3 on the insulating layer 2, in which the first metal layer 3 includes a plurality of electrode bridges 31.

Step S4: deposing a layer of SiN or SiON on the first metal layer 3 to form a passivation layer 4, and disposing a via hole 8 on the passivation layer 4, in which a width of the via hole ranges from 1.4 μm to 1.6 μm.

Step S5: recessing the first metal layer 3 to form a recess 9 at a position corresponding to the via hole 8, in which a bottom of the recess 9 is disposed at a half thickness of the first metal layer 3. The present invention achieves the connection between the first metal layer 3 and the second metal layer 5 by using the via hole 8 and the recess 9, so as to increase the contact area of the two metal layers, reduce the sheet resistance, improve the reliability of metal mesh at a connection, increase the strength of the connection, and improve the touch performance. Further, the widened feature at the connection improves the flexible dynamic bending performance. A side wall of the via hole 8 is at an angle of 15° to 30° to a perpendicular of a bottom edge of the via hole 8.

Step S6: recessing the first metal layer 3 to form a recess 9 at a position corresponding to the via hole 8, in which a side wall of the recess 9 and the side wall of the via hole 8 are connected and parallel; that is to say, the side wall of the recess 9 is also at an angle of 15° to 30° to a perpendicular of a bottom edge of the recess 9. The slope of the via hole 8 and the recess 9 can further improve the reliability of metal mesh at a connection, increase the strength of the connection, and increase the contact area with the second metal layer 5. In addition, the connection between the first metal layer 3 and the second metal layer 5 is so wide as to reduce the sheet resistance.

Step S7: forming a second metal layer 5 on the passivation layer 4, in which the second metal layer 5 includes a plurality of touch electrodes 51 and a plurality of metal traces 52, the touch electrode 51 includes a first electrode 511 and a second electrode, the first electrode 511 and the second electrode are insulated from each other, two adjacent first electrodes 511 are electrically connected to each other through the electrode bridge 31 along a first direction, and two adjacent second electrodes are electrically connected to each other through the metal trace 52, which is in a same layer as the second electrode, along a second direction which crosses the first direction. In other words, the first electrode 511 is arranged along the first direction and has a mesh structure, and two adjacent first electrodes 511 are electrically connected to each other along the first direction to form a first touch sensing part. Further, the second electrode is arranged along a second direction, which crosses the first direction, and has the mesh structure, and two adjacent second electrodes are electrically connected to each other along the second direction to form a second touch sensing part. The first touch sensing part and the second touch sensing part are insulated from each other through the passivation layer 4 to form a bridge structure. The plurality of touch electrodes 51 are arranged in an array. Each of the touch electrodes 51 can be in the shape of round, triangular or other shape. Each of the touch electrodes 51 is connected to a corresponding touch electrode wire (i.e., the first touch sensing part and the second touch sensing part as described above). The touch electrode wire is connected to a touch chip (not shown), such that a touch signal sensed by the touch electrode 51 is delivered to the touch chip; that is to say, the first metal layer 3 and the second metal layer 5 form a TX-RX touch wiring. The principle of the touch control performed by the plurality of touch electrodes 51 is described below: if a human body does not touch the screen, then the capacitance sensed by the touch electrode 51 will be a constant value; if a human body touches the screen, for example, preforming an operation on the screen by finger, then the capacitance sensed by the touch electrode 51 at a position where the finger touches the screen will be changed due to the influence of the human body. By detecting the change of capacitance of each of the capacitive touch electrodes, the position touched by the finger can be determined, such that touch function can be achieved.

Step S8: forming a planar layer 6 on the second metal layer 5, in which the planar layer 6 is made of polymethyl methacrylate (PMMA), and a thickness of the planar layer 6 is 2 μm. The planar layer 6 is configured to fill the patterned second metal layer 5 and make its surface smooth.

Step S9: forming a polarizing plate 7 on the planar layer 6, in which the polarizing plate 7 is configured for polarization of a light.

In one embodiment, the first metal layer 3 or the second metal layer 5 may include a first titanium layer, an aluminum layer, and a second titanium layer, which are disposed in a stack. Specifically, the aluminum layer is disposed at a side of the first titanium layer, and the second titanium layer is disposed at a side of the aluminum layer away from the first titanium layer. The first metal layer 3 or the second metal layer 5 may also include a silver nanowire (AgNW). A width of the first metal layer 3 or the second metal layer 5 is 3 μm.

In one embodiment, the first metal layer 3 and the second metal layer 5 are different in their thickness. The thickness of the first titanium layer of the first metal layer 3 is 0.03 μm. The thickness of the aluminum layer of the first metal layer 3 is 0.14 μm. The thickness of the second titanium layer of the first metal layer 3 is 0.03 μm. That is to say, the total thickness of the first metal layer 3 is 0.2 μm. The thickness of the first titanium layer of the second metal layer 5 is 0.05 μm. The thickness of the aluminum layer of the second metal layer 5 is 0.28 μm. The thickness of the second titanium layer of the second metal layer 5 is 0.05 μm. That is to say, the total thickness of the first metal layer 5 is 0.38 μm.

In one embodiment, the second metal layer 5 serves as a common electrode layer of the array substrate 10 at the same time. In the display phase, the plurality of touch electrode wires of the first metal layer 3 input a common electrode signal which is necessary for display, such that each of the touch electrodes 51 of the second metal layer 5 has the common electrode signal, thereby achieving display. In the touch scanning phase, the plurality of touch electrode wires serve as a touch lead connected to the touch chip, such that the sensing signals from each of the touch electrodes 51 can be delivered to the touch chip, thereby achieving touch function.

Referring to FIG. 5, the present invention further provides a touch panel 200. The touch panel is a liquid crystal display panel having touch function, and includes the array substrate 10 as described above, a color filter 30, and a liquid crystal layer 20 between the array substrate 10 and the color filter 30.

Certainly, in other embodiment, the touch panel may be an OLED display panel or other display panel which has touch function.

The benefits of the present invention are described below:

The present invention provides a touch screen and a manufacturing method thereof. By etching a via hole, the contact area of two metal layers is increased, the sheet resistance is reduced, the reliability of metal mesh at a connection is improved, the strength of the connection is increased, and the touch performance is improved. Further, the widened feature at the connection improves the flexible dynamic bending performance.

In the above, the present invention has been described in the above preferred embodiments. It shall be identified that a person skilled in the art may make various improvements and modifications without departing from the principle of the present invention, and such improvements and modifications shall be covered by the scope of the present invention.

What is claimed is:

1. A touch screen, comprising an array substrate, wherein the array substrate comprises:
a thin film encapsulation layer;
an insulating layer, wherein the insulating layer is disposed on the thin film encapsulation layer;
a first metal layer, wherein the first metal layer is disposed on the insulating layer;
a passivation layer, wherein the passivation layer is disposed on the first metal layer;
a second metal layer, wherein the second metal layer is disposed on the passivation layer; and
a planar layer, wherein the planar layer is disposed on the second metal layer;
wherein the first metal layer comprises a plurality of electrode bridges, the second metal layer comprises a plurality of touch electrodes and a plurality of metal traces; the touch electrode comprises a first electrode and a second electrode, the first electrode and the second electrode are insulated from each other, two adjacent first electrodes are electrically connected to each other along a first direction through the electrode bridge, and two adjacent second electrodes are electrically connected to each other along a second direction, which crosses the first direction, through the metal trace;
wherein a plurality of via holes are disposed on the passivation layer, the via hole is formed as a hole-shaped structure having a gradually decreasing inner diameter from a surface of the passivation layer close to the first electrode of the second metal layer toward an end of the electrode bridge of the first metal layer, the electrode bridge is recessed to form a recess at a position corresponding to the via hole, and the first electrode extends through the via hole into the recess of the electrode bridge and electrically connected to the first electrode.

2. The touch screen according to claim 1, wherein a width of the via hole ranges from 1.4 μm to 1.6 μm.

3. The touch screen according to claim 1, wherein a side wall of the via hole is at an angle of 15° to 30° to a perpendicular of a bottom edge of the via hole.

4. The touch screen according to claim 1, wherein a bottom of the recess is disposed at a half thickness of the first metal layer.

5. The touch screen according to claim 1, wherein the first metal layer or the second metal layer comprises:
a first titanium layer;
an aluminum layer, wherein the aluminum layer is disposed at a side of the first titanium layer; and
a second titanium layer, wherein the second titanium layer is disposed at a side of the aluminum layer away from the first titanium layer.

6. The touch screen according to claim 1, wherein the first metal layer or the second metal layer comprises a silver nanowire.

7. A method of manufacturing a touch screen, comprising:
providing an array substrate, wherein the array substrate comprises a thin film encapsulation layer;
forming an insulating layer on the thin film encapsulation layer;
forming a first metal layer on the insulating layer, wherein the first metal layer comprises a plurality of electrode bridges;
forming a passivation layer on the first metal layer;
disposing a via hole on the passivation layer;
recessing the first metal layer to form a recess at a position corresponding to the via hole;
forming a second metal layer on the passivation layer, wherein the second metal layer comprises a plurality of touch electrodes and a plurality of metal traces, the touch electrode comprises a first electrode and a second electrode, the first electrode and the second electrode are insulated from each other, two adjacent first electrodes are electrically connected to each other along a first direction through the electrode bridge, and two adjacent second electrodes are electrically connected to each other along a second direction, which crosses the first direction, through the metal trace, and wherein the via hole is formed as a hole-shaped structure having a gradually decreasing inner diameter from a surface of the passivation layer close to the first electrode of the second metal layer toward an end of the electrode bridge of the first metal layer, the electrode bridge is recessed to form a recess at a position corresponding to the via hole, and the first electrode extends through the via hole into the recess of the electrode bridge and is electrically connected to the first electrode; and
forming a planar layer on the second metal layer.

8. The method of manufacturing the touch screen according to claim 7, wherein a width of the via hole ranges from 1.4 μm to 1.6 μm.

9. The method of manufacturing the touch screen according to claim 7, wherein a side wall of the via hole is at an angle of 15° to 30° to a perpendicular of a bottom edge of the via hole.

10. The method of manufacturing the touch screen according to claim 7, wherein a bottom of the recess is disposed at a half thickness of the first metal layer.
